(19) United States
(12) Patent Application Publication
(10) Pub. No.: US 2017/0267153 A1
(43) Pub. Date: Sep. 21, 2017

(54) LIVESTOCK TRAILER WITH ENCLOSED ELEVATOR PLATFORM

(71) Applicant: Anthony K. Novero, Omaha, NE (US)

(72) Inventor: Anthony K. Novero, Omaha, NE (US)

(73) Assignee: Anthony K. Novero, Omaha, NE (US)

(21) Appl. No.: 15/072,466

(22) Filed: Mar. 17, 2016

(51) Int. Cl. B60P 3/04; B65G 43/00; A01K 13/00; B62D 63/08; B60P 1/44; A01K 1/02; B65G 67/02

(52) U.S. Cl. CPC B60P 3/04; A01K 1/0236; B65G 43/00; B65G 67/02; B62D 63/08; B60P 1/4421; A01K 13/00

(57) ABSTRACT

The present invention relates in general to the field of livestock trailers, and more specifically, to a livestock trailer that utilizes an enclosed elevator platform for loading and unloading animals. The elevator platform is located within an elevator shaft inside the frame of the livestock trailer. The elevator platform is configured to protect and confine the livestock as it traverses through the elevator shaft during loading and unloading operations. The livestock trailer may further comprise a ventilation system, a sprinkler system and/or a watering system to help assist in the well-being, health, and safety of the livestock while being transported. The purpose of the invention is to provide a livestock trailer and method of loading and unloading livestock onto the livestock trailer that minimizes risk of serious injury to both animal and handler during loading, unloading and transportation operations.

### FIELD OF THE INVENTION

The present invention relates in general to the field of livestock trailers, and more specifically, to a livestock trailer that utilizes an enclosed elevator platform for loading and unloading livestock. The purpose of the invention is to provide a livestock trailer and method of loading and unloading livestock onto the livestock trailer that minimizes risk of serious injury to both animal and handler. An additional purpose of the invention is to provide a livestock trailer and a method of loading and unloading livestock onto the livestock trailer that is efficient, convenient and easy to operate.

### BACKGROUND OF THE INVENTION

Loading and unloading livestock onto a livestock trailer is undoubtedly the most stressful and injurious stage of the farming operation for both man and beast. This stage, coupled with the transportation of livestock between farm and slaughterhouse, may significantly impact an animal's well-being and production. For instance during the loading and unloading operation, livestock may become frightened from loud noises, unfamiliar surroundings and tight confinements. Frightened livestock have a tendency to spook easily, leading to animals being kicked, gored, trampled and crushed. Such dangerous conditions may cause fractures, dislocations, punctures, bruising or death. A lack of ventilation and available water may also result in undue stress, heat stroke, suffocation and dehydration. For example, improper ventilation or simply, a lack of oxygen, may result in an accumulation of exhaust fumes from road vehicles and/or ammonia from urine with subsequent poisoning. Some types of livestock (e.g., swine, poultry) are particularly susceptible to excessive heat, poor air circulation, high humidity and respiratory stress. Thus, the loading and unloading of livestock, including transportation, can have serious deleterious effects on the welfare of livestock that unfortunately result in a significant loss of quality and production.

Handlers also face serious risks while loading or unloading livestock onto a livestock trailer. Injuries often occur when handlers are required to place themselves in a dangerous situation (e.g., in between livestock and/or inside a confined space) to move the livestock onto a livestock trailer. Other injuries occur when handlers are required to place their limbs through openings in a livestock trailer or loading/unloading ramp to move livestock on/off the livestock trailer. Other times the floor of the loading/unloading ramp may be too steep out of a necessity to reach the upper floors of a livestock trailer, requiring the handler to herd livestock at unsafe heights and increasing the risk of falls, slips and trips to both the handler and animal alike. Thus, the handlers must be able to anticipate and avoid dangerous situations instigated by unpredictable animals in a stressful environment, particularly when loading livestock via a loading/unloading ramp.

Unfortunately, livestock trailer designs currently used in the industry do not mitigate the aforementioned risks involved during the loading, unloading and transportation operations. Typically, livestock trailers are vertically divided into a plurality of floors. Depending upon the particular livestock trailer design, these floors may be raised or lowered according to the height of the livestock being transported. In order to load livestock onto the uppermost floors, handlers may use auxiliary interior or exterior loading/unloading ramps. When utilizing loading/unloading ramps, handlers load the livestock onto the uppermost floors first and gradually move toward the lower floors. The unloading process is performed in reverse, wherein the lower floors are initially unloaded and the handlers gradually move toward the upper floors. Thus, utilizing a loading/unloading ramp requires the livestock to navigate a steep incline or decline in order to reach the uppermost floors of the livestock trailer. As mentioned previously, this creates an unsafe environment with an increased risk of the animal falling, slipping and tripping that can result in serious injury. Such loading procedures also require the handlers to work at unsafe height conditions that may result in serious injury.

In an attempt to mitigate such risks, other livestock trailer designs have incorporated an exterior loading platform extending from the rear of the livestock trailer. The exterior loading platform may be lowered to ground surface, wherein livestock may be herded onto the exterior loading platform via a loading chute or loading ramp. The exterior loading platform may then be raised until it is parallel to a desired floor of the livestock trailer. The livestock may then be unloaded from the exterior loading platform onto the desired floor of the livestock trailer and the process repeated until the livestock trailer is fully loaded. While this design alleviates concerns associated with utilizing a loading/unloading ramp, significant problems remain.

For instance, the exterior loading platform extends from the rear of the loading/unloading ramp and is therefore suspended 10-15 feet in midair when loading livestock onto the uppermost floors of the livestock trailer. At this height, serious injury and even fatality may result if an animal gets spooked and simply jumps off of the exterior loading platform. Moreover, such designs require a handler to be present on the exterior loading platform as it is suspended in midair from the rear of the trailer to herd the livestock onto each floor of the livestock trailer. As mentioned previously, injuries often occur when handlers are required to place themselves in between livestock and/or in a confined space with livestock. In addition to these creating these dangerous conditions for both animal and handler, such a design is inconvenient in that the exterior loading platform extends several feet beyond the rear of the livestock trailer. Such an extension creates navigational hazards for the driver and compounds difficulties already associated with reversing a livestock trailer up to a feedlot or livestock processing facility for loading and unloading purposes.

Thus, a desire remains to provide a livestock trailer that does not require an auxiliary loading/unloading ramp when loading and unloading livestock, as such loading/unloading ramps increase the risk of injury and stress for both animals and handlers. A desire also remains to provide a livestock trailer that does not require an exterior loading platform that extends beyond the rear of the livestock trailer, as such loading platforms increase the risk of injury for both animals and handlers and create a navigational hazard for the driver. A further desire remains to provide a livestock trailer and method of loading and unloading livestock that minimizes the aforementioned safety and security concerns, while maximizing efficiency and operational convenience.

### BRIEF SUMMARY OF THE INVENTION

Therefore, it is a principal object, feature, and/or advantage of the present invention to overcome the aforementioned deficiencies in the art and provide a livestock trailer and method of loading and unloading livestock onto a livestock trailer that utilizes an enclosed elevator platform for loading and unloading animals.

Another object, feature, and/or advantage of the present invention is to provide a livestock trailer and method of loading and unloading livestock onto a livestock trailer that minimizes safety and security concerns.

Yet another object, feature, and/or advantage of the present invention is to provide a livestock trailer and method of loading and unloading livestock onto a livestock trailer that maximizes efficiency and operational convenience for a livestock handler.

A further object, feature, and/or advantage of the present invention is to provide a livestock trailer and method of loading and unloading livestock onto a livestock trailer that does not require an auxiliary loading/unloading ramp when loading and unloading livestock.

A still further object, feature, and/or advantage of the present invention is to provide a livestock trailer and method of loading and unloading livestock onto a livestock trailer that does not require an exterior loading platform that extends beyond the rear of the livestock trailer.

Another object, feature, and/or advantage of the present invention is to provide a livestock trailer and method of loading and unloading livestock onto a livestock trailer that is convenient to clean and maintain.

Yet another object, feature, and/or advantage of the present invention is to provide a livestock trailer and method of loading and unloading livestock onto a livestock trailer that comprises a ventilation system for the livestock.

A further object, feature, and/or advantage of the present invention is to provide a livestock trailer and method of loading and unloading livestock onto a livestock trailer that comprises an animal watering system for on-demand access to water.

A still further object, feature, and/or advantage of the present invention is to provide a livestock trailer and method of loading and unloading livestock onto a livestock trailer that comprises a sprinkler system for cooling and hydrating livestock.

Another object, feature, and/or advantage of the present invention is to provide a livestock trailer and method of loading and unloading livestock onto a livestock trailer that is free of a chassis.

Yet another object, feature, and/or advantage of the present invention is to provide a livestock trailer and method of loading and unloading livestock onto a livestock trailer wherein the floors of the livestock trailer are adjustable in height according to the height of the livestock being transported.

A further object, feature, and/or advantage of the present invention is to provide a livestock trailer and method of loading and unloading livestock onto a livestock trailer wherein the roof in its entirety or a portion of the roof of the livestock trailer may rise vertically, swing open or slide open.

A still further object, feature, and/or advantage of the present invention is to provide a livestock trailer and method of loading and unloading livestock onto a livestock trailer that comprises a control system for operating all components of the livestock trailer.

These and/or other objects, features, and/or advantages of the present invention will be apparent to those skilled in the art. The present invention is not to be limited to or by these objects, features, and advantages. No single aspect need provide each and every object, feature, or advantage.

According to one aspect of the present invention, a livestock trailer includes a self-supporting rectangular frame. The livestock trailer further comprises an enclosed elevator platform located within an elevator shaft inside the frame. As used herein, the terms “inside” and “within” may be used interchangeably. The elevator platform may include a corral comprised of a plurality of guard rails, an access door and a separate egress door. The corral is configured to protect and confine the livestock as the elevator platform traverses through the elevator shaft during loading and unloading operations. The livestock trailer may further comprise a ventilation system, a sprinkler system and/or a watering system to help assist in the well-being, health, and safety of the livestock while being transported. The elevator platform, ventilation system, sprinkler system and watering systems may be operated using a control system. The control system may comprise a control panel and a plurality of sensors measuring temperature, humidity, and contaminant conditions inside the livestock trailer, including the real-time location of the elevator platform on any particular floor. Corrective action may be taken upon reviewing data obtained from the plurality of sensors, wherein such data may indicate unsatisfactory interior conditions of the livestock trailer.

According to another aspect of the present invention a method of loading and unloading livestock onto a livestock trailer is provided. The method includes providing a plurality of livestock and at least one handler to herd the livestock. The method further comprises providing a livestock trailer with an enclosed elevator platform located within an elevator shaft inside the frame. The method may also include providing a ventilation system, a sprinkler system and/or a watering system to help assist in the well-being, health, and safety of the livestock while being transported. The elevator platform, ventilation system, sprinkler system and watering systems may be operated using a control system. The control system comprises a control panel and a plurality of sensors measuring temperature, humidity, and contaminant conditions inside the livestock trailer, including the real-time location of the elevator platform on any particular floor. The method of loading and unloading livestock further comprises providing a towing vehicle, wherein the towing vehicle may be attached to the front of the livestock trailer. The livestock trailer may be reversed up to a loading/unloading chute, loading/unloading ramp or livestock confinement building using the towing vehicle for livestock loading or unloading purposes. Livestock may be herded into the corral of the elevator platform, wherein the loaded elevator platform may be elevated to an upper floor and unloaded until a desired number of livestock have disembarked from the corral of the elevator platform and entered the floor. The elevator platform may then be lowered to the bottom floor and the process repeated until the floors and bottom floor of the livestock trailer are full of the desired number of livestock for transport and shipping. The unloading operation is carried out in the same manner but reversing the aforementioned steps. The method of the present invention further comprises reviewing data obtained from the plurality of sensors, wherein such data may indicate unsatisfactory interior conditions of the livestock trailer. Corrective action may then be taken, wherein such corrective action may include adjusting the elevator platform, ventilation system, sprinkler system and watering system to provide optimal safety and health conditions for the livestock during transportation.

Different aspects may meet different objects of the invention. Other objectives and advantages of this invention will be more apparent in the following detailed description taken in conjunction with the figures. The present invention is not to be limited by or to these objects or aspects.

### DESCRIPTION OF FIGURES

FIGS. 1-12 represent examples of livestock trailers of the present invention, and a method of loading and unloading livestock onto a livestock trailer of the present invention.

FIG. 1 is an exterior side and rear view of the livestock trailer of the present invention.

FIG. 2 is a sectional view of the F-channel of the livestock trailer of FIG. 1.

FIG. 2A is a close-up view of the F-channel of the livestock trailer of FIG. 2.

FIG. 3 is an interior side and rear view of the livestock trailer of FIG. 1.

FIG. 4 is a sectional view of the enclosed elevator platform of the livestock trailer of FIG. 3.

FIG. 5 is a rear view of the interior of the livestock trailer of FIG. 1 with the series of trap doors open.

FIG. 6 is a top view of the livestock trailer of FIG. 1 with portions of the roof open.

FIG. 7 is a view of a vertical guide for the enclosed elevator platform of the livestock trailer of FIG. 1.

FIG. 8 is a sectional view of the enclosed elevator platform of FIG. 4 acting as a ramp.

FIG. 9 is a side view of the ventilation system of the livestock trailer of FIG. 1.

FIG. 10 is a rear view of the sprinkler and watering systems of the livestock trailer of FIG. 1.

FIG. 11 is a side and rear view of the control system of the livestock trailer of FIG. 1.

FIG. 12 is a view of the control panel of the livestock trailer of FIG. 11.

### DETAILED DESCRIPTION OF THE INVENTION

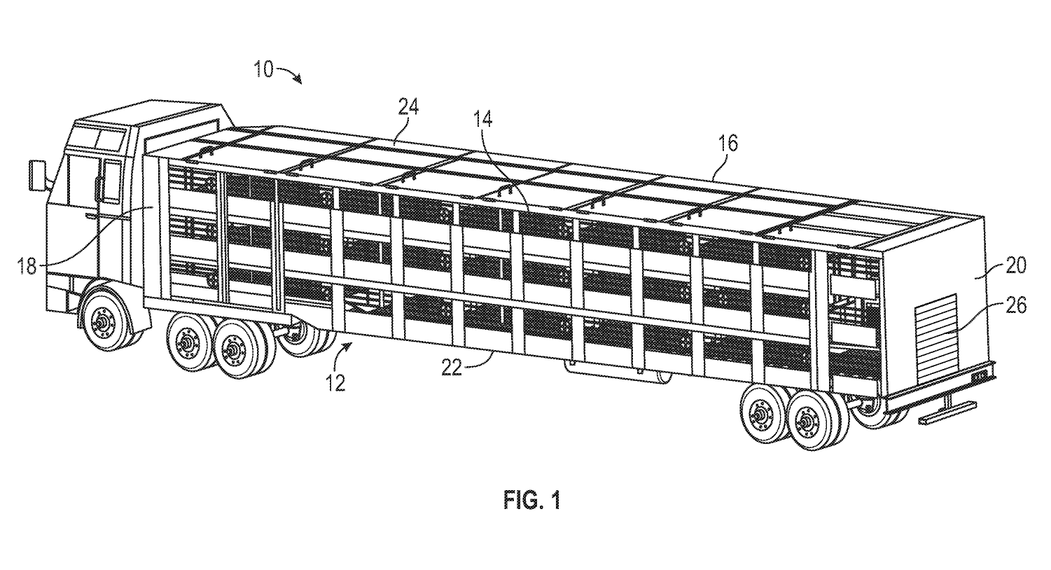

FIG. 1 illustrates a side view of one aspect of a livestock trailer (10) of the present invention that improves the safety of both livestock (e.g., beef cattle, dairy cattle, swine, sheep, horses, goats, poultry, etc.) and handlers (e.g., stockman, rancher, cowboy, farmer, etc.). The livestock trailer (10) may be constructed of light-weight and rust-resistant aluminum. Alternatively, the livestock trailer (10) may be constructed of heavy-duty steel, high-strength high-performance steel (e.g., DOMEX®) or combinations of steel and aluminum. The livestock trailer (10) may comprise a means for towing the livestock trailer (10) from a towing vehicle such as a truck or semi. The livestock trailer (10) may also include 2-10 wheels and 1-3 axles, wherein at least one axle may be retractable to provide extra clearance when turning. The livestock trailer (10) may include a chassis or remain chassis-free to reduce weight during transportation and lower costs during manufacture.

Shown in FIG. 1, the livestock trailer (10) includes a self-supporting frame (12). The frame (12) may comprise: a first side wall (14); an opposite second side wall (16); a front wall (18); an opposite rear wall (20); a bottom floor (22); and, a roof (24). The frame (12) may be configured to form a rectangular shape. Dimensions of the frame (12) may comprise a width of between 95-105 inches, a length of between 45-55 feet, and a height of between 10-15 feet. The frame (12) may include translucent material for improved visibility inside the livestock trailer (10) and/or insulated panels for thermal protection of the livestock transported therein. The frame (12) may further comprise panels and/or openings for improved ventilation and visibility, in addition to escape doors with fold down step cleats (not shown). The frame (12) may comprise a rear door (26) integrated into the rear wall (20) and/or side walls (14, 16). The rear door (26) may be configured to allow livestock and/or handlers to access the interior of the livestock trailer (10), wherein the rear door (26) may be of a type standardly used in the industry (e.g., hinged, roll-up, sliding, swinging, etc.).

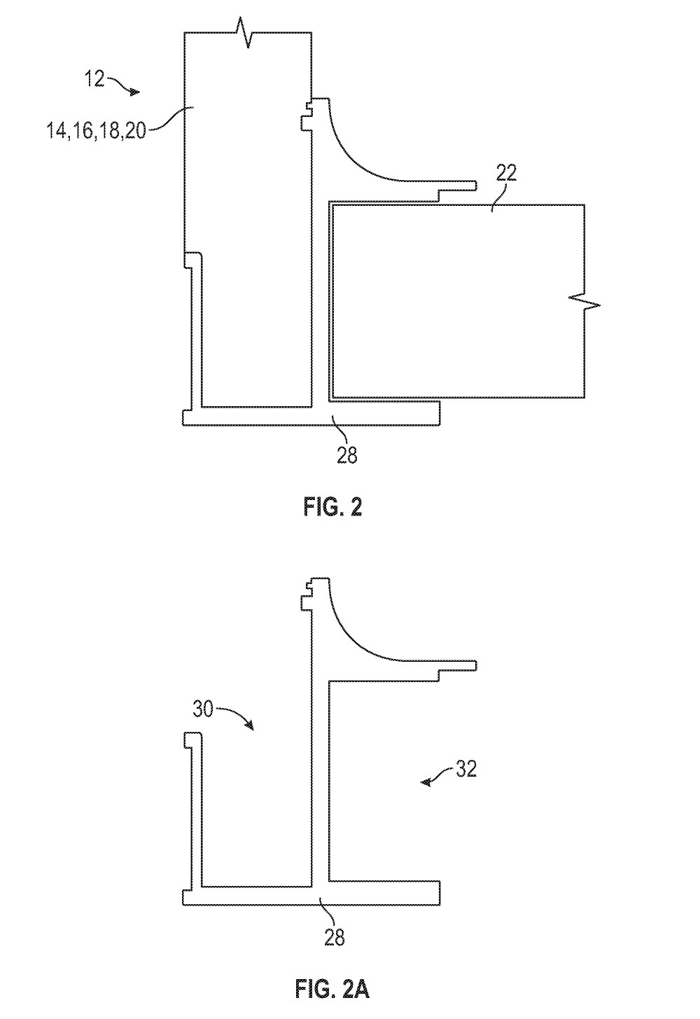

Illustrated in FIGS. 2 and 2A, the frame (12) may comprise an F-channel (28) that connects the side walls (14, 16), front wall (18), and rear wall (20) to the bottom floor (22) of the livestock trailer (10). The F-channel (28) may be constructed of light-weight and rust-resistant aluminum, heavy-duty steel, high-strength high-performance steel (e.g., DOMEX®) or combinations of steel and aluminum. The F-channel (28) may comprise a first slot (30) configured to fit a bottom edge of side walls (14, 16), front wall (18), and rear wall (20). The F-channel (28) further includes a second slot (32) configured to fit a lateral edge of the bottom floor (22). The side walls (14, 16), front wall (18), and rear wall (20) may be welded, bolted, or otherwise affixed into their respective slots (30, 32) of the F-channel (28) to secure the walls therein.

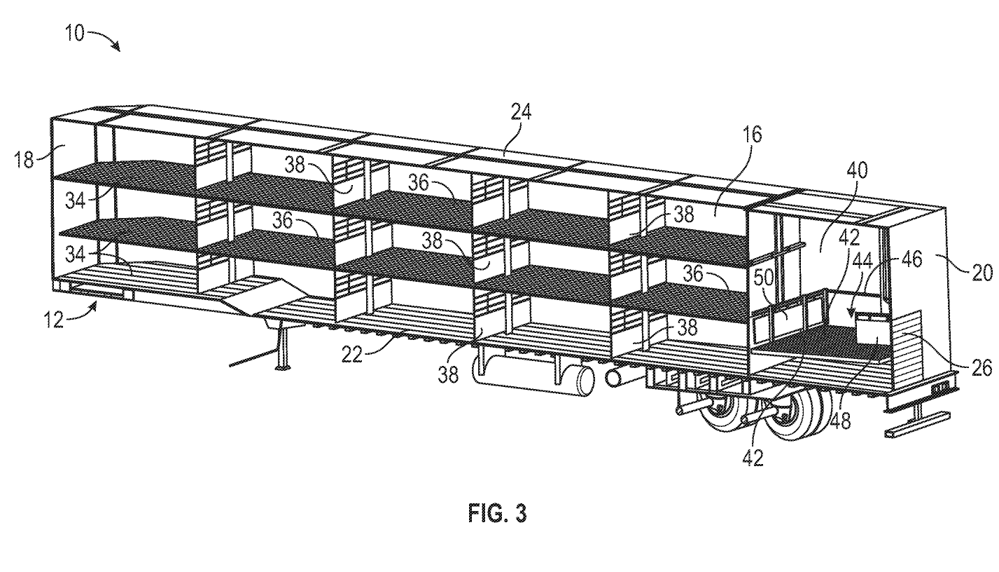

Illustrated in FIG. 3, the livestock trailer (10) of the present invention may comprise a single floor (34) (e.g., bottom floor (22)) or a plurality of floor(s) (34). In particular, the plurality of floor(s) (34) may comprise between 2-5 floors, including bottom floor (22). The floor(s) 34 may be height adjustable to accommodate livestock of varying heights to maximize space and efficiency when transported, wherein such height adjustability may be standard in the industry. Alternatively, the floor(s) 34 may be non-adjustable and set at fixed heights to accommodate the height and size of a particular animal for transportation purposes. Each floor (34) may comprise a plurality of pens 36 (e.g., 4-6 pens) configured to confine livestock therein. Each pen (36) may further comprise a gate (38) to allow animals to enter and exit the pen (36).

Shown in FIG. 3, the livestock trailer (10) of the present invention may comprise an elevator shaft (40) rising vertically through the floors (34) of the livestock trailer (10) which allows for passage of an elevator platform 42 from floor to floor (34). The elevator shaft (40) may be located towards the rear of the frame (12) and adjacent the rear wall (20) of the livestock trailer (10). The elevator platform (42) may reside within the elevator shaft (40), and is configured to traverse up and down the elevator shaft (40). In particular, the elevator platform (42) may be enclosed within the elevator shaft (40) inside the frame (12) of the livestock trailer (10), particularly, within the first and second side walls (14, 16), front wall (18), rear wall (20), bottom floor (22) and the roof (24). The elevator platform (42) may include a weighing scale (not shown) for accurately determining the weight of livestock being loaded onto the livestock trailer (10). The walking surface of the elevator platform (42) and floor(s) 34 of the livestock trailer (10) may comprise tread plating, grating, grooves and/or other types of non-slip flooring to secure the footing of both the livestock and the handlers.

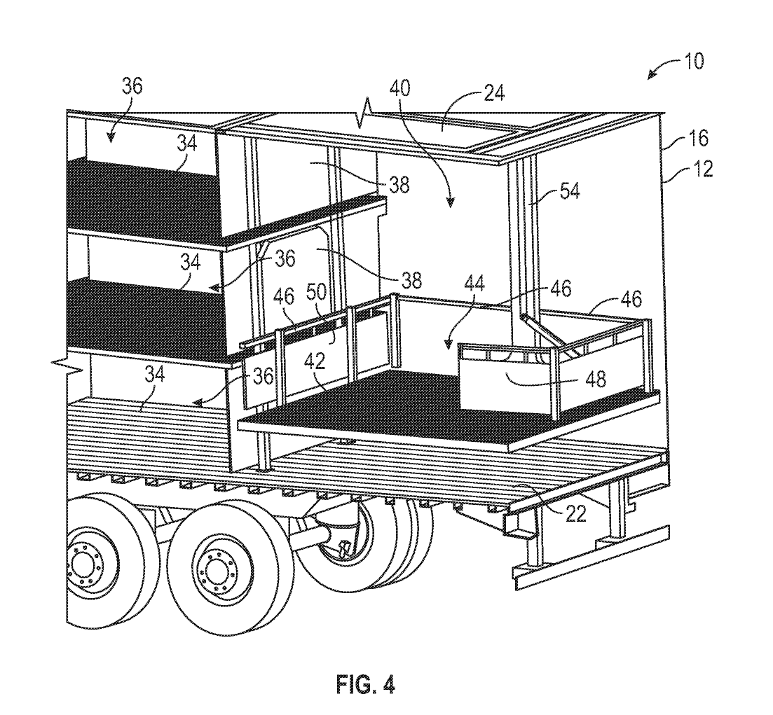

Illustrated in FIG. 4, the elevator platform (42) may include a corral (44) comprised of a plurality of guard rails (46), an access door (48) and an egress door (50). The corral (44) is configured to protect and confine the livestock on the elevator platform (42). The size of the corral (44) may be equivalent to the size of the pen(s) (36) on the floor(s) 34 of the livestock trailer (10). Thus, the same number of animals may fit in both the corral (44) and the pen (36). The access door (48) of the corral (44) may be configured to align with the rear door (26) when the elevator platform (42) is on the bottom floor (22) of the livestock trailer (10). Thus, livestock may be loaded into the corral (44) through an open rear door (26) and access door (48). After a desired number of livestock have entered the corral (44), the access door (48) may be closed to confine the livestock on the elevator platform (42). The elevator platform (42) is configured to traverse up and down the elevator shaft (40) and stop at any particular floor (34), wherein livestock may be unloaded through an open egress door (50) of the corral (44). In this manner, livestock may be safely loaded onto the floor(s) 34 of the livestock trailer (10) using the enclosed elevator platform (42). Livestock may be safely unloaded from the livestock trailer (10) in the same manner albeit in reverse.

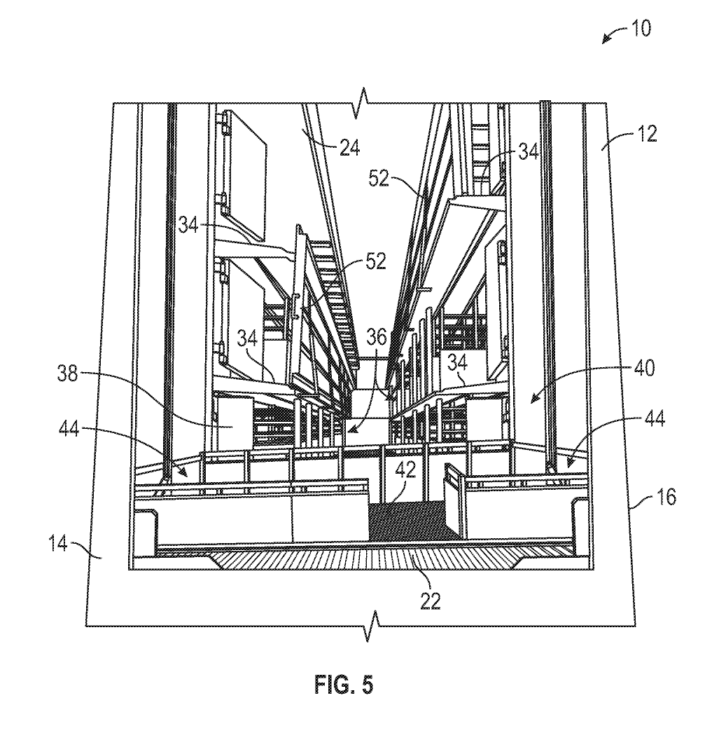

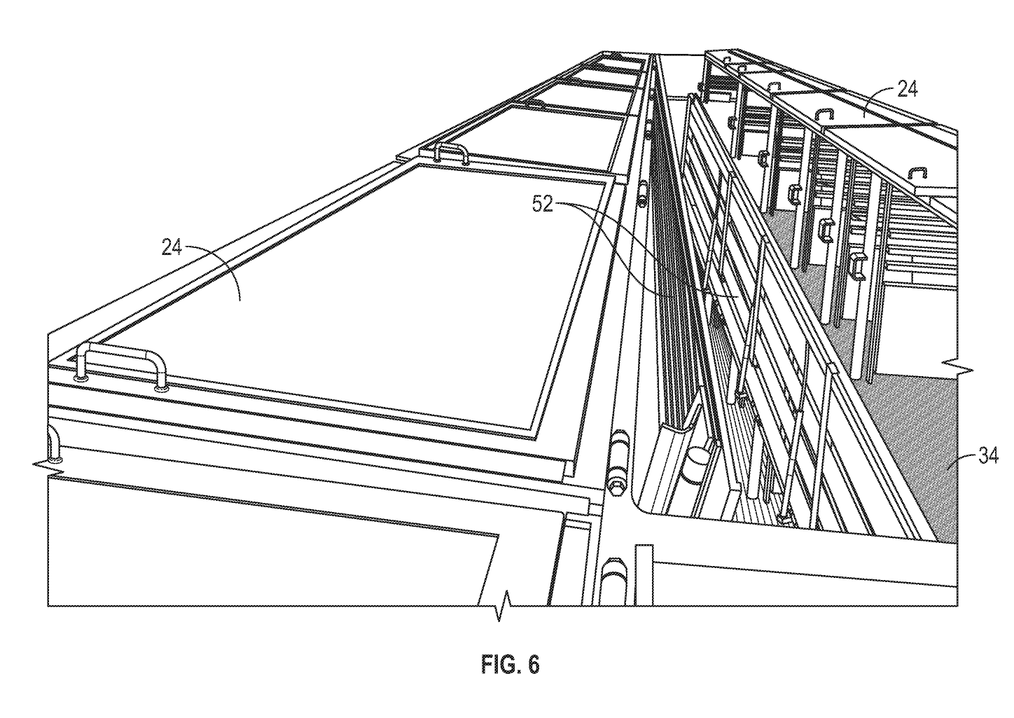

Illustrated in FIG. 5, the floor(s) 34 may comprise a series of trap doors (52). The series of trap doors (52) are configured to assist a handler in herding livestock towards the front of the livestock trailer (10). For instance, a handler located on a floor (34) may walk upright the entire length of the livestock trailer (10) after the series of trap doors (52) have been opened on upper floors. Further illustrated in FIG. 6, the roof (24) or portions thereof may be configured to open. In particular, the roof (24) or portions thereof may be configured to swing open via hinges, slide open, or rise vertically via a series of hydraulics and supporting columns. An open roof (24) conveniently allows a handler to walk upright as he/she herds livestock on the uppermost floor (34) of the livestock trailer (10).

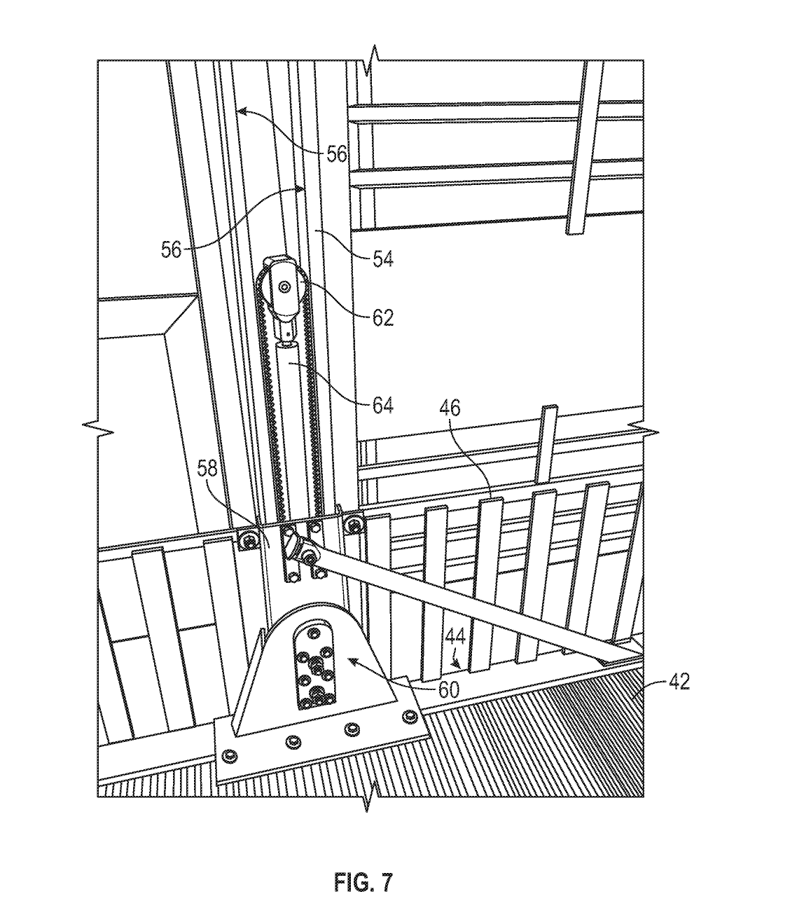

Illustrated in FIG. 7, the livestock trailer (10) of the present invention further comprises at least one support column (54). The support column (54) may be temporarily affixed and/or permanently integrated into the first and/or second side walls (14, 16) of the frame (12). The support column (54) may comprise a vertical guide (56) and a slidable element (58), wherein the slidable element (58) is configured to traverse along the vertical guide (56). The slidable element (58) may be fastened to the elevator platform (42) via an elevator platform fastening device (60). The elevator platform fastening device (60) may fasten the elevator platform (42) to the slidable element (58) using welds, integral construction, bolts, axles and/or other means of fastening common in the industry. The slidable element (58) may be connected to a roller chain pulley system (62) powered by a hydraulic cylinder (64). The roller chain pulley system (62) may vertically raise and lower the elevator platform (42) within the elevator shaft (40) (e.g., as similarly utilized in forklifts). The foregoing example is detailed for illustrative purposes only, as it is contemplated that the elevator platform (42) may also be moved vertically by other mechanical means common in the industry. Ultimately, the elevator platform (42) may be configured to move vertically within the elevator shaft (40) between the bottom floor (22) of the frame (12) and the floor(s) (34) of the livestock trailer (10) while the corral (44) of the elevator platform (42) is full of livestock. The elevator platform (42) may also be configured to stop at any floor (34) of the livestock trailer for livestock loading and unloading purposes.

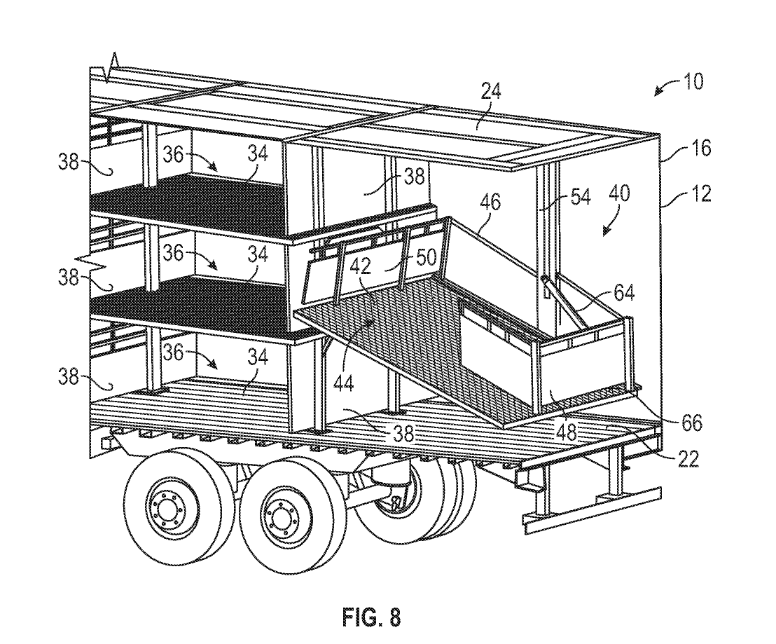

Illustrated in FIG. 8, the elevator platform fastening device (60) may rotatably fasten the elevator platform (42) to the slidable element (58), wherein an additional hydraulic cylinder may be configured to tilt the elevator platform (42) on a horizontal axis. Particularly useful in a livestock trailer (10) comprising two floor(s) (34) (e.g., a double-decker trailer), such a design allows the elevator platform (42) to tilt and therefore act as a ramp (66) for loading livestock onto an upper floor (34). The elevator platform (42) may be cantilevered to reduce any gap between the ramp (66) and an edge of the floor (34) to prevent the livestock from tripping, breaking bones, or causing serious injury as they enter or exit the corral (44). After a desired number of livestock have entered the livestock trailer (10) via the ramp (66), the elevator platform (42) may be straightened horizontally and additional livestock loaded into the corral (44) for shipping and transportation purposes.

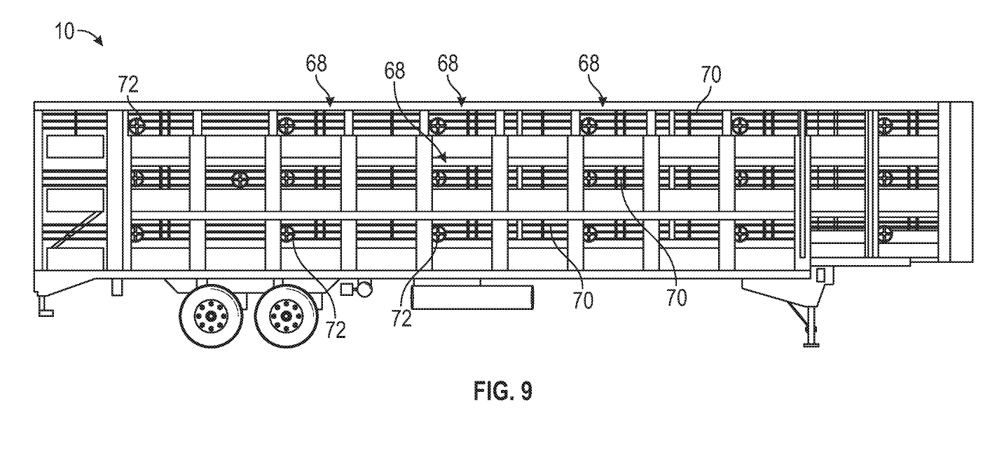

Illustrated in FIG. 9, the livestock trailer (10) of the present invention further comprises a ventilation system (68). The ventilation system (68) may comprise a plurality of air vents (70), or openings, incorporated into the side walls (14, 16), front wall (18) and rear wall (20). The air vents (70) may further include electric fans (72) to improve circulation, wherein the air vents (70) and electric fans (72) may be placed strategically on every floor (34) of the livestock trailer (10) to provide optimal air movement and ventilation. The size of the air vents (70) may be independently controlled electronically via a plurality of sliding or rotating panels (not shown) that allow for an increase or decrease in air movement throughout the livestock trailer (10). The panels may be double-walled with an intermediate air chamber to provide better insulation against extreme cold temperatures outside the livestock trailer (10). It is contemplated that other types of insulation standard in the industry may be incorporated into the design of the livestock trailer (10). The electric fans (72) may be independently controlled to turn on/off and have variable speeds that further provide for an increase or decrease in air movement throughout the livestock trailer (10).

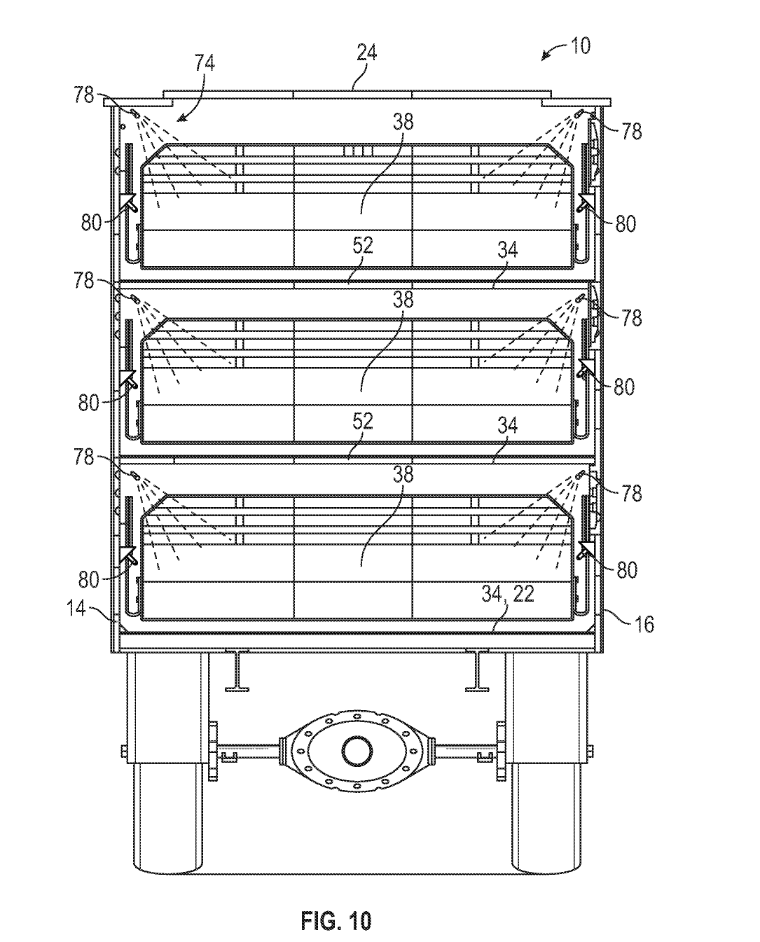

Illustrated in FIG. 10, the livestock trailer (10) of the present invention further comprises a sprinkler system (74) and/or a watering system (76). The sprinkler system (74) may comprise a series of sprinkler heads (78) strategically located on a ceiling of every floor (34) of the livestock trailer (10) to reach the maximum number of livestock on the floor 22, 30. The sprinkler heads (78) may distribute water over the livestock inside the livestock trailer (10) to help prevent overheating, heat stroke and death. The watering system (76) may comprise a series of watering nozzles (80) strategically placed on every floor (34) of the livestock trailer (10). Each floor (34) may have a plurality of watering nozzles (80). Providing each floor (34) of the livestock trailer (10) with a plurality of watering nozzles (80) facilitates easy access for livestock to drink while confined inside the livestock trailer to help prevent dehydration, sickness, injury and death. Moreover, providing each floor (34) of the livestock trailer (10) with their own independent watering nozzles (80) prevents the spread of disease and cross-contamination that often arises when utilizing a communal watering trough. Both sprinkler and watering systems (74, 76) may comprise an on-board water reservoir tank (not shown) filled with water. Water from the water reservoir tank may be fed to a pump (not shown) through a pressurized supply line that pressurizes the sprinkler and watering systems (74, 76). The pump may be driven via battery, electric motor, generator, air pressure, or other type of electrical supply connected to, or independent from, the towing vehicle. By utilizing a plumbed, pressurized supply line water may be evenly distributed to sprinkler heads (78) and watering nozzles (80) placed at strategic locations inside the livestock trailer (10) to help assist in the well-being, health, and safety of the livestock while inside the livestock trailer (10). It is contemplated by the present invention that the sprinkler and watering systems (74, 76) may function when the livestock trailer (10) is attached to and/or detached from the towing vehicle.

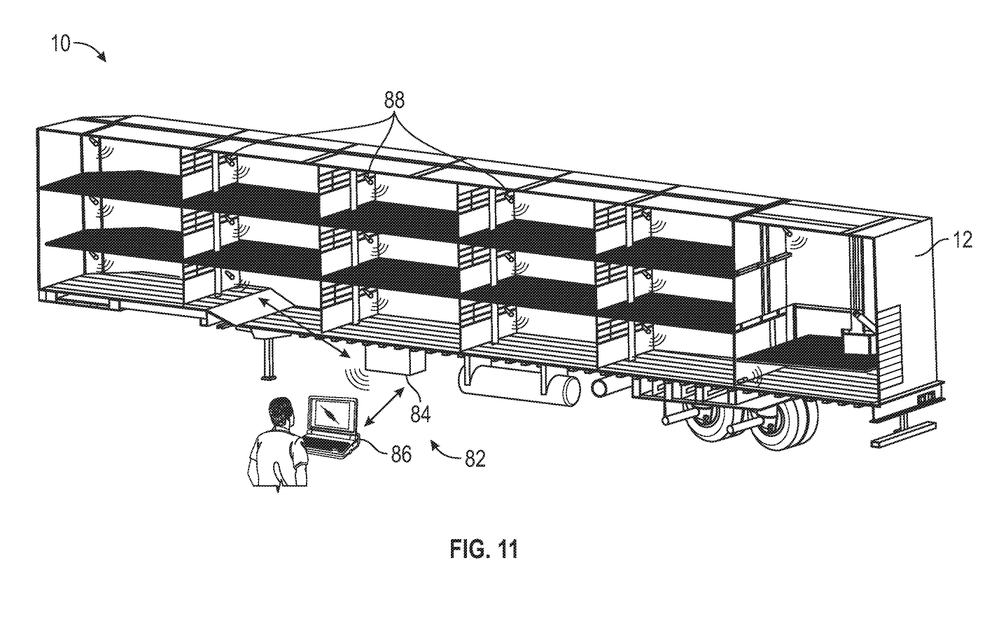

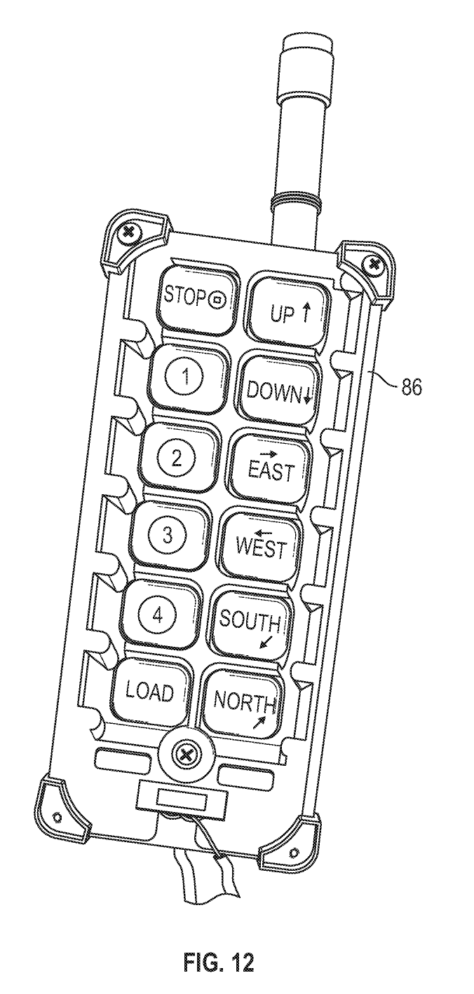

Illustrated in FIGS. 11 and 12, the livestock trailer (10) of the present invention further comprises a control system (82). The control system (82) may include a server (84) located proximate to or remote from the livestock trailer (10), a control panel (86) and a plurality of sensors (88). The plurality of sensors (88) may obtain data measuring temperature, humidity and contaminant conditions inside the livestock trailer (10). The plurality of sensors (88) may also obtain data determining the real-time location of the elevator platform (42) on any particular floor (34) of the livestock trailer (10), including when the rear door (26) opens and closes. The plurality of the sensors (88) may further obtain data detecting real-time movement within the livestock trailer (10), including under the elevator platform (42), to help prevent animals and handlers from being crushed or trampled. The plurality of sensors (88) may also obtain GPS data to determine the real-time location of the livestock trailer (10). The plurality of sensors (88) may transmit the data to the server (84), wherein the server (84) may receive the data and further transmit it to the control panel (86). The data may be transmitted to and from the server (84) via cables or wirelessly using the Internet, a local area network, satellite and/or other means common in the industry. Wireless transmitters and receivers utilized by the control system (82) may be of any commercially available type, wherein the precise wireless transmitter/receiver not being a limitation of the present invention.

Illustrated in FIG. 12, the control panel (86) may comprise a remote control for operating the elevator platform (42), ventilation system (68), watering system (76) and sprinkler system (74) of the livestock trailer (10). Alternatively, the control panel (86) may comprise a laptop, computer, smart phone, tablet or similar device for operating the elevator platform (42), ventilation system (68), watering system (76) and sprinkler system (74) of the livestock trailer (10), wherein the control panel (86) includes a display for viewing the data obtained from the plurality of sensors (88). The control panel (86) may transmit operating instructions inputted into the control panel (86) to the server (84) for executing the received commands. Corrective action may also be taken upon reviewing the data obtained from the plurality of sensors (88), wherein such data may indicate unsatisfactory or dangerous conditions inside the livestock trailer (10). Such corrective action may include an operator manually adjusting the elevator platform (42), ventilation system (68), sprinkler system (74) and watering system (76) via the control panel (86). Alternatively, the control system (82) may automatically take corrective action according to preset instructions set forth by the operator. It is contemplated by the present invention that the control system (82) may be operational when the livestock trailer (10) is attached to and/or detached from the towing vehicle.

FIGS. 1-12 illustrate another aspect of the present invention, a method of loading and unloading livestock onto a livestock trailer that improves the safety of both livestock and handlers. The method of the present invention comprises providing a plurality of livestock (e.g., beef cattle, dairy cattle, swine, sheep, horses, goats, poultry, etc.) and at least one handler (e.g., stockman, rancher, cowboy, farmer, etc.) to herd the livestock. As shown in FIGS. 1-12, the method comprises providing the aforementioned livestock trailer (10). The method may also comprise providing ventilation system (68) (FIG. 9), sprinkler system (74) and/or watering system (76) (FIG. 10). The method may further comprise providing control system (82), wherein the control system (82) may include the server (84), the plurality of sensors (88), and the control panel (86) (FIGS. 11-12).

Illustrated in FIGS. 1-4, the method of the present invention further comprises providing a towing vehicle (e.g., semi or truck), wherein the towing vehicle may be attached to the front of the livestock trailer (10). The method further comprises using the towing vehicle to reverse the livestock trailer (10) up to a loading/unloading chute, ramp or livestock confinement building for livestock unloading and loading purposes. At this time, the elevator platform (42) may be initially lowered to reside on the bottom floor (22). After the livestock trailer (10) is in a proper position for loading/unloading purposes, the access door (48) of the corral (44) and the rear door (26) of the livestock trailer (10) may both be opened.

Shown in FIGS. 1-4, the method further comprises driving the livestock through the open rear door (26) of the livestock trailer (10). Livestock may be driven by a handler using vocal encouragement and/or a “persuader” (e.g., flags, plastic paddles, sticks and electric prods). Upon traversing the rear door (26), the livestock are further driven into the corral (44) of the elevator platform (42) through the open access door (48). After a desired number of livestock have entered the corral (44), the access door (48) may be closed wherein the livestock are confined inside the corral (44) of the elevator platform (42).

Illustrated in FIG. 4, the method of the present invention further comprises loading the bottom floor (22) of the livestock trailer (10) with livestock first. The elevator platform (42) may remain on the bottom floor (22) while the bottom floor (22) is being loaded with livestock. The egress door (50) of the corral (44) may be opened to allow livestock to enter the bottom floor (22), wherein the egress door (50) may be closed thereafter. The pen (36) closest to the front of the livestock trailer (10) may be loaded first. As mentioned previously, each pen (36) conveniently holds the same number of animals as the corral (44). To better assist a handler in herding livestock towards the front of the livestock trailer (10), the series of trap doors (52) on upper floor(s) (34) may be opened to allow the handler to walk upright the entire length of the livestock trailer (10). After the livestock are loaded into the pen (36), its respective gate (38) and overhead trap doors (52) may be closed to effectively confine the livestock therein. The corral (44) is again filled with livestock and the steps repeated—working from the front of the livestock trailer (10) towards the rear—until all remaining pens 36 on the bottom floor (22) are full of a desired number of livestock.

Shown in FIGS. 4 and 8, the floor (34) directly above the bottom floor (22) may be loaded next with livestock. In particular, the elevator platform (42) may be lowered through the elevator shaft (40) to reside on the bottom floor (22). Livestock may then be herded through the open rear door (26) of the livestock trailer (10) and the adjoining access door (48) into the corral (44). After the corral (44) is full of a desired number of livestock and the access door (48) and the egress door (50) have both been closed, the enclosed elevator platform (42) may rise through the elevator shaft (40) to the floor (34) directly above the bottom floor (22). Once the elevator platform (42) is adjacent to floor (34), the egress door (50) of the corral 44 may be opened to permit the livestock to safely disembark from the corral (44) and enter the floor (34). The egress door (50) of the corral (44) may be closed thereafter. Similar to loading the bottom floor (22), the pen (36) on the floor (34) nearest the front of the livestock trailer (10) may be loaded first. As mentioned previously, each pen (36) conveniently holds the same number of animals as the corral (44). To better assist a handler in herding livestock towards the front of the livestock trailer (10), the series of trap doors (52) may remain open to allow the handler to walk upright the entire length of the livestock trailer (10). After the livestock are loaded into the pen (36), its respective gate (38) and overhead trap doors (52) may be closed to effectively confine the livestock therein. The elevator platform (42) may then be lowered through the elevator shaft to reside on the bottom floor (22). Livestock may then be herded through the open rear door (26) of the livestock trailer (10) and the adjoining access door (48) into the corral (44). The aforementioned steps may then be repeated—working from the front of the livestock trailer (10) towards the rear—until all remaining pens 36 on the floor (34) are full of a desired number of livestock. Alternatively, the elevator platform (42) may be tilted and used as a ramp to herd livestock onto the floor (34).

Further shown in FIGS. 4 and 8, the remaining floor(s) (34) of the livestock trailer (10) may be loaded in a similar manner-gradually working upwards-until all floor(s) (34) are full of a desired number of livestock. To better assist a handler in herding livestock off the elevator platform (42) and onto the top floor (34), a portion of the roof (24)—or the roof (24) in its entirety—may be configured to swing open, slide open, or rise vertically. Therefore, a handler may be able to stand and walk upright on the top floor (34) when herding livestock thereon. After all floor(s) (34) of the livestock trailer (10) are full of a desired number of livestock, the corral (44) may also be loaded with livestock and confined therein. The elevator platform (42) may then be raised in the elevator shaft (40). Additional livestock may then be loaded onto the bottom floor (22)—below the elevator platform (42) and within the elevator shaft (40)—to provide further space on the livestock trailer (10) for shipping and transportation purposes.

Also shown in FIGS. 4 and 8, livestock may be unloaded from the livestock trailer (10) in the same manner, albeit in reverse. For instance, any livestock confined within the elevator shaft (40) and under the elevator platform (42) may be unloaded first through an open rear door (26) of the livestock trailer (10). The elevator platform (42) may then be lowered to reside on the bottom floor (22). Livestock confined within the corral (44) of the elevator platform (42) may next be unloaded through an open access door (48) of the corral (44) and an open rear door (26) of the livestock trailer (10). The empty elevator platform (42) may next be raised through the elevator shaft (40) to unload the top floor (34) of the livestock trailer (10). The top floor (34) may be unloaded working from the rear of the livestock trailer (10) towards the front, wherein livestock are released from pens 36 via their respective gates 34. Particularly, livestock may be herded from the top floor (34) onto the elevator platform (42), through an open egress door (50), and thereafter confined within the corral (44). The elevator platform (42) may then be lowered to reside on the bottom floor (22). Livestock may disembark the elevator platform (42) through an open access door (48) of the corral (44) and the adjoining rear door (26) of the livestock trailer (10). The access door (48) of the corral (44) may then be closed and the aforementioned steps repeated until the top floor (34) has been emptied of a desired number of livestock. The remaining floor(s) (34) of the livestock trailer (10) may be unloaded in a similar manner—gradually working downwards—until all floor(s) (34) are emptied of a desired number of livestock. Alternatively, the elevator platform (42) may be tilted and used as a ramp (66) to unload livestock from the floor 20 directly above the bottom floor (22). Thus, the method of the present invention for loading and unloading livestock utilizing the enclosed elevator platform (42) improves the safety and well-being of the livestock and/or handlers as the elevator platform (42) traverses through the plurality of floor(s) (34) of the livestock trailer (10) via the elevator shaft (40).

Illustrated in FIGS. 11-12, the method of the present invention further comprises reviewing data obtained from the plurality of sensors (88), wherein such data may indicate unsatisfactory interior conditions of the livestock trailer (10). Corrective action may then be taken, wherein such corrective action may include adjusting the elevator platform (42), ventilation system (68), sprinkler system (74) and watering system (76) to provide optimal safety and health conditions for the livestock during transportation. Corrective action may be taken manually by an operator or, alternatively, the control system (82) may automatically take corrective action according to preset instructions as set forth by the operator.

The livestock trailer (10) of the present invention and method of loading and unloading livestock are universally applicable to livestock trailers of all shapes and sizes, makes, models, and manufacturers. Furthermore, while intended for swine, the livestock trailer (10) of the present invention and method of loading and unloading livestock may be used for all manner of livestock, including beef cattle, dairy cattle, sheep, horses, goats, and poultry. Although the invention has been described and illustrated with respect to preferred aspects thereof, it is not to be so limited since changes and modifications may be made therein which are within the full intended scope of the invention.

What is claimed is:

1: A livestock trailer that can be towed behind a vehicle, comprising:
a frame configured to transport livestock;
a plurality of floors;
an elevator shaft inside the frame; and
an elevator platform within the elevator shaft;
wherein the plurality of floors are configured to confine livestock inside the frame;
wherein the elevator shaft rises vertically through the plurality of floors;
wherein the elevator platform is configured to transport livestock to and from the plurality of floors;
wherein the elevator platform is enclosed within the frame of the livestock trailer.

2: The livestock trailer of claim 1, further comprising:
a first side wall;
an opposite second side wall;
a front wall;
a rear wall;
a roof;
a bottom floor; and
a rear door;
wherein the first and second side walls, front wall, rear wall, roof and bottom floor form the frame of the livestock trailer;
wherein the rear wall and/or side walls include the rear door.

3: The livestock trailer of claim 2, further comprising:
at least one pen on each floor; and
a gate configured to confine livestock in each pen.

4: The livestock trailer of claim 3, further comprising:
a corral located on the elevator platform within the elevator shaft;
wherein the corral comprises:
a) a plurality of guard rails;
b) an access door; and
c) an egress door;
wherein the corral is configured to protect and confine the livestock as the elevator platform traverses through the plurality of floors of the livestock trailer via the elevator shaft.

5: The livestock trailer of claim 4, further comprising:
the access door of the corral is configured to align with the rear door when loading or unloading livestock onto the elevator platform; and
the egress door of the corral is configured to allow livestock onto the floors when loading or unloading livestock from the elevator platform.

6: The livestock trailer of claim 1, further comprising:
a ventilation system, wherein the ventilation system comprises:
a) a plurality of air vents; and
b) a plurality of fans;
wherein the plurality of air vents and fans are placed on every floor of the livestock trailer;
wherein the ventilation system is configured to provide optimal air movement and ventilation to the livestock inside the livestock trailer.

7: The livestock trailer of claim 6, further comprising:
a sprinkler system, wherein the sprinkler system comprises:
a) a series of sprinkler heads; and
b) a water reservoir tank;
wherein the series of sprinkler heads are placed on the ceiling of every floor of the livestock trailer to reach the maximum number of livestock on the floor;
wherein the sprinkler system is configured to help prevent overheating, heat stroke and death of the livestock on the livestock trailer.

8: The livestock trailer of claim 7, further comprising:
a watering system, wherein the watering system comprises:
a) a series of watering nozzles; and
b) a water reservoir tank;
wherein the series of watering nozzles are placed on every floor of the livestock trailer;
wherein each floor may have a plurality of watering nozzles;
wherein the watering system is configured to facilitate easy access for livestock to drink while confined inside the livestock trailer to help prevent dehydration, sickness, injury and death.

9: The livestock trailer of claim 8, further comprising:
a control system, wherein the control system comprises:
a) a plurality of sensors; and
b) a control panel;
wherein the plurality of sensors measure temperature, humidity, and/or contaminant conditions inside the livestock trailer;
wherein the plurality of sensors determine the real-time location of the elevator platform on any particular floor of the livestock trailer;
wherein the control panel displays data obtained from the plurality of sensors;
wherein the control panel provides inputs for operating the elevator platform, ventilation system, sprinkler system and/or watering systems.

10: The livestock trailer of claim 1, further comprising:
an F-channel between the bottom floor and the front wall, rear wall, first side wall, and second side wall of the frame.

11: The livestock trailer of claim 1, further comprising:
wherein a portion of the roof slides open, swings open, or raises vertically to allow a handler to stand and walk upright on the uppermost floor when herding livestock thereon.

12: A livestock trailer that can be towed behind a vehicle, comprising:
a frame configured to transport livestock, wherein the frame comprises:
a) a first side wall;
b) an opposite second side wall;
c) a front wall;
d) a rear wall;
e) a roof;
f) a bottom floor; and
g) a rear door;
h) wherein the rear wall and/or side walls include the rear door;
a plurality of floors inside the frame, wherein the plurality of floors comprise:
a) the bottom floor;
b) at least one floor located above the bottom floor; and
c) at least one pen on each floor;
d) wherein the plurality of floors are configured to confine livestock;
an elevator shaft inside the frame, wherein the elevator shaft rises vertically through the plurality of floors;
an elevator platform within the elevator shaft; and
a corral located on the elevator platform within the elevator shaft, wherein the corral comprises:
a) a plurality of guard rails;
b) an access door;
c) the access door configured to align with the rear door of the rear wall of the frame when loading or unloading livestock onto the elevator platform;
d) an egress door; and
e) the egress door configured to allow livestock to load or unload from the elevator platform onto the floors of the livestock trailer;
wherein the elevator platform is configured to transport livestock to and from the plurality of floors via the elevator shaft;
wherein the corral is configured to protect and confine the livestock as the elevator platform traverses through the plurality of floors of the livestock trailer via the elevator shaft;
wherein the elevator platform is enclosed within the frame of the livestock trailer.

13: The livestock trailer of claim 12, further comprising:
a ventilation system, wherein the ventilation system comprises:
a) a plurality of air vents; and
b) a plurality of fans;
wherein the plurality of air vents and fans are placed on every floor of the livestock trailer;
wherein the ventilation system is configured to provide optimal air movement and ventilation to the livestock inside the livestock trailer.

14: The livestock trailer of claim 13, further comprising:
a sprinkler system, wherein the sprinkler system comprises:
a) a series of sprinkler heads; and
b) a water reservoir tank;
wherein the series of sprinkler heads are placed on the ceiling of every floor of the livestock trailer to reach the maximum number of livestock on the floor;
wherein the sprinkler system is configured to help prevent overheating, heat stroke and death of the livestock on the livestock trailer.

15: The livestock trailer of claim 14, further comprising:
a watering system, wherein the watering system comprises:
a) a series of watering nozzles; and
b) a water reservoir tank;
wherein the series of watering nozzles are placed on every floor of the livestock trailer;
wherein each floor may have a plurality of watering nozzles;
wherein the watering system is configured to facilitate easy access for livestock to drink while confined inside the livestock trailer to help prevent dehydration, sickness, injury and death.

16: The livestock trailer of claim 15, further comprising:
a control system, wherein the control system comprises:
a) a plurality of sensors; and
b) a control panel;
wherein the plurality of sensors measure temperature, humidity, and/or contaminant conditions inside the livestock trailer;
wherein the plurality of sensors determine the real-time location of the elevator platform on any particular floor of the livestock trailer;
wherein the control panel displays data obtained from the plurality of sensors;
wherein the control panel provides inputs for operating the elevator platform, ventilation system, sprinkler system and/or watering systems.

17: A method of loading and unloading livestock onto a livestock trailer, comprising:
providing a plurality of livestock;
providing at least one handler to herd the livestock;
providing a livestock trailer, the livestock trailer comprising;
a) a frame configured to transport livestock;
b) a plurality of floors inside the frame;
c) an elevator shaft inside the frame; and
d) an elevator platform within the elevator shaft;
e) wherein the plurality of floors are configured to confine livestock;
f) wherein the elevator shaft rises vertically through the plurality of floors;
g) wherein the elevator platform is configured to transport livestock to and from the plurality of floors;
h) wherein the elevator platform is enclosed within the frame of the livestock trailer;
providing a towing vehicle to tow the livestock trailer;
driving the livestock into the elevator platform within the elevator shaft;
traversing the loaded elevator platform through the plurality of floors of the livestock trailer via the elevator shaft;
unloading the livestock from the elevator platform onto a floor inside the frame;
confining the livestock on the floor inside the frame;
traversing the unloaded elevator platform through the plurality of floors of the livestock trailer via the elevator shaft;
repeating the aforementioned steps until the livestock trailer is full of a desired number of livestock for transportation;
transporting the livestock to a desired location via the towing vehicle and livestock trailer;
unloading the livestock utilizing the elevator platform within the elevator shaft inside the frame of the livestock trailer.

18: The method of loading and unloading livestock onto a livestock trailer of claim 17, further comprising:
ventilating the frame of the livestock trailer using a ventilation system, wherein the ventilation system comprises:
a) a plurality of air vents; and
b) a plurality of fans;
wherein the plurality of air vents and fans are placed on every floor of the livestock trailer;
wherein the ventilation system is configured to provide optimal air movement and ventilation to the livestock inside the livestock trailer.

19: The method of loading and unloading livestock onto a livestock trailer of claim 18, further comprising
hydrating livestock inside the livestock trailer using a sprinkler system, wherein the sprinkler system comprises:
a) a series of sprinkler heads; and
b) a water reservoir tank;
c) wherein the series of sprinkler heads are placed on the ceiling of every floor of the livestock trailer to reach the maximum number of livestock on the floor;
d) wherein the sprinkler system is configured to help prevent overheating, heat stroke and death of the livestock on the livestock trailer;
providing drinking water to livestock inside the livestock trailer using a watering system, wherein the watering system comprises:
a) a series of watering nozzles; and
b) a water reservoir tank;
c) wherein the series of watering nozzles are placed on every floor of the livestock trailer;
d) wherein each floor may have a plurality of watering nozzles;
e) wherein the watering system is configured to facilitate easy access for livestock to drink while confined inside the livestock trailer to help prevent dehydration, sickness, injury and death.

20: The method of loading and unloading livestock onto a livestock trailer of claim 19, further comprising:
operating the elevator platform, ventilation system, watering system and sprinkler system using a control system, wherein the control system comprises:
a) a plurality of sensors; and
b) a control panel;
c) wherein the plurality of sensors measure temperature, humidity, and/or contaminant conditions inside the livestock trailer;
d) wherein the plurality of sensors determine the real-time location of the elevator platform on any particular floor of the livestock trailer;
e) wherein the control panel displays data obtained from the plurality of sensors;
f) wherein the control panel provides inputs for operating the elevator platform, ventilation system, sprinkler system and/or watering systems.
